(19) United States
(12) Patent Application Publication
(10) Pub. No.: US 2007/0144657 A1
(43) Pub. Date: Jun. 28, 2007

(54) Green tire evolution for high speed uniformity

(76) Inventors: Julien Flament, Greer, SC (US); James Michael Traylor, Greer, SC (US)

Correspondence Address: MICHELIN NORTH AMERICA, INC.;INTELLECTUAL PROPERTY DEPARTMENT, MARC BLDG 31-2, 515 MICHELIN ROAD, GREENVILLE, SC, 29605, US

(21) Appl. No.: 11/638,028

(22) Filed: Dec. 13, 2006

Related U.S. Application Data
(63) Continuation-in-part of application No. 11/320,370, filed on Dec. 28, 2005.

(51) Int. Cl. B60C 19/00

(52) U.S. Cl. 156/110.1; 152/154.1

(57) ABSTRACT

A method for controlling uniformity in tire manufacturing includes the steps of measuring the radial runout of an uncured tire carcass, modeling the radial force variation contribution of the carcass from the radial runout measurement, measuring the thickness of the tire tread, modeling the mass imbalance of the tread from the tread thickness measurement, forming a green tire by loading the tread onto the carcass at an angle whereby the radial force variation contribution of the carcass is opposed to the tread mass imbalance determined from the tread mass imbalance model, and placing the green tire in a curing press at an angle which minimizes the radial force variation or mass imbalance of the green tire.

This application is a continuation-in-part of previously filed U.S. application Ser. No. 11/320,370 entitled Green Tire Evolution for High Speed Uniformity, which was filed Dec. 28, 2005.

### SUMMARY OF THE INVENTION

A method for controlling the uniformity of tires in tire manufacture, comprises the steps of measuring the radial runout of an uncured tire carcass, modeling the radial force variation contribution of the carcass from the radial runout measurement, measuring the thickness of the tire tread, modeling the mass imbalance of the tread from the tread thickness measurement, forming a green tire by loading the tread onto the carcass at an angle whereby the radial force variation vector contribution of the carcass is opposed to the tread mass imbalance vector determined from the tread mass imbalance model, and placing the green tire in a curing press at an angle which minimizes the radial force variation or mass imbalance of the green tire.

The method for controlling the uniformity of tires in tire manufacture, further comprises the steps of measuring the radial runout of an uncured tire carcass, modeling the radial force variation contribution of the carcass from the radial runout measurement, by means of calculating a proportionality coefficient relating the radial runout of the carcass due to the effect of loading the carcass on the building drum to radial force variation due to loading effects, multiplying the loading proportionality constant by the average loading radial runout to calculate a loading radial force variation, calculating a proportionality coefficient relating the radial runout of the carcass due to confection effects to radial force variation due to confection effects, multiplying the confection proportionality constant by the confection radial runout to calculate a confection radial force variation, summing the confection radial force variation and the loading radial force variation, measuring the thickness of the tire tread, modeling the mass imbalance of the tread from the tread thickness measurement, forming a green tire by loading the tread onto the carcass at an angle whereby the radial force variation contribution of the carcass is opposed to the tread mass imbalance determined from the tread mass imbalance model, and placing the green tire in a curing press at an angle which minimizes the radial force variation of the green tire.

### BRIEF DESCRIPTION OF THE DRAWINGS

FIG. 1 is a schematic view of a tire showing a frame of reference.

FIG. 2 is a vector polar plot showing the various contributors to green tire radial runout and the resulting radial runout.

FIG. 3 is a mass variation curve with the X axis representing the angular position of the tire and the Y axis representing average tread runout across the width of the tread.

FIG. 4 is an optimization routine for improving the uniformity of a tire.

### DESCRIPTION OF PREFERRED EMBODIMENTS OF THE INVENTION

Tire uniformity relates to a tire's symmetry or asymmetry relative to its axis of rotation in terms of physical characteristics such as mass, geometry, and stiffness. Tire uniformity characteristics, or attributes, are generally categorized in terms of dimensional or geometric parameters (variations in radial run out, lateral run out, and conicity), mass (variance in mass imbalance about the axis), and rolling force (radial force variation, lateral force variation, and tangential force variation, sometimes also called longitudinal or fore and aft force variation). These values are typically decomposed into Fourier harmonics then reported as a vector, with the magnitude as the peak or maximum value and the direction given relative to the axis of rotation of the tire.

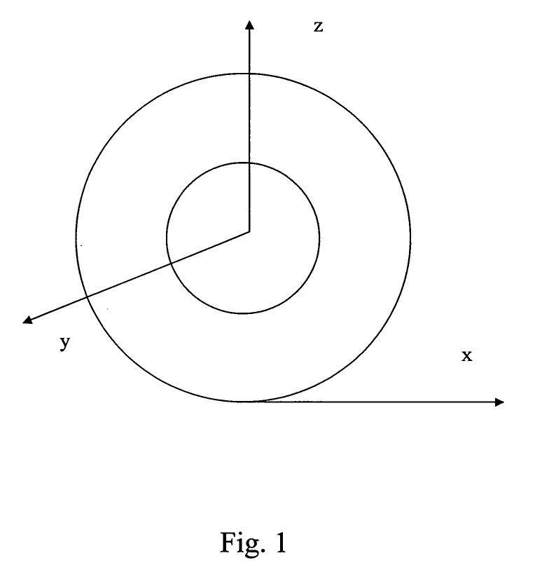

FIG. 1 shows a schematic view of a tire 10 showing a frame of reference for various uniformity attributes. The different rolling force variations are typically identified with a particular direction, for example, fore and aft, longitudinal, or tangential force variation along the x axis, lateral force variation along the y axis, and radial (or vertical) force variation along the z axis.

Direct measurement of high speed attributes tends to be time consuming and requires expensive test equipment. To overcome these difficulties, methods have been developed for using low speed attribute measurements to predict high speed attributes. An example of such a method is disclosed in U.S. Pat. No. 6,842,720 (Chang), which is commonly assigned with the instant application. This patent discloses a method for using Partial Least Square (PLS) regression techniques for relating low speed and geometric attributes to high speed attributes.

A set of identical tires (tires of the same model and size and made at the same time according to an identical process) were test for uniformity, and the results show differences in uniformity existed from tire to tire. In measuring the change in radial force variation from low speed (corresponding to about 10 kph) to high speed (corresponding to about 140 kph), the inventors noticed that while some tires showed an increase in radial force, others showed no increase or even a decrease. A method that identifies the factors responsible for these differences and the factors to control the differences may improve the high speed uniformity of tires.

The steps illustrated below provide for the modification of the tire building or manufacturing process to adjust selected uniformity attributes to reduce the measured variance in uniformity, and to thereby improve at least the tire's functional uniformity. The method initially measures the carcass for radial runout and then generates a model of radial force variation based upon the carcass runout measurements. This model represents a sum of vector contributors which can then be optimized to reduce non-uniformity. The method then measures the tread radial runout and generates a model of the tread mass imbalance based on the tread runout measurements. The tire high speed performance can then be predicted and optimized. The particular steps described below represent a preferred embodiment of the invention, and should not be read as limiting.

According to the invention, a method for controlling the uniformity of tires includes the step of building tires according to a series of defined process steps. As is known in the art, these process steps might include steps of laying plies or layers of different materials on a building drum, for example, the inner liner, carcass ply or plies, belts, sidewall covers, and tread. In addition, other products, such as the bead rings, bead reinforcement strips, and shoulder reinforcement strips, are positioned on the drum. Then, in the case of a multi-stage tire building process, the assembly may be removed from the drum and is conformed to the toroidal tire shape. The conformed tire is placed in a mold, and heat and pressure are applied to form the shape features (tread pattern, sidewall markings, etc.) and to cure the rubber.

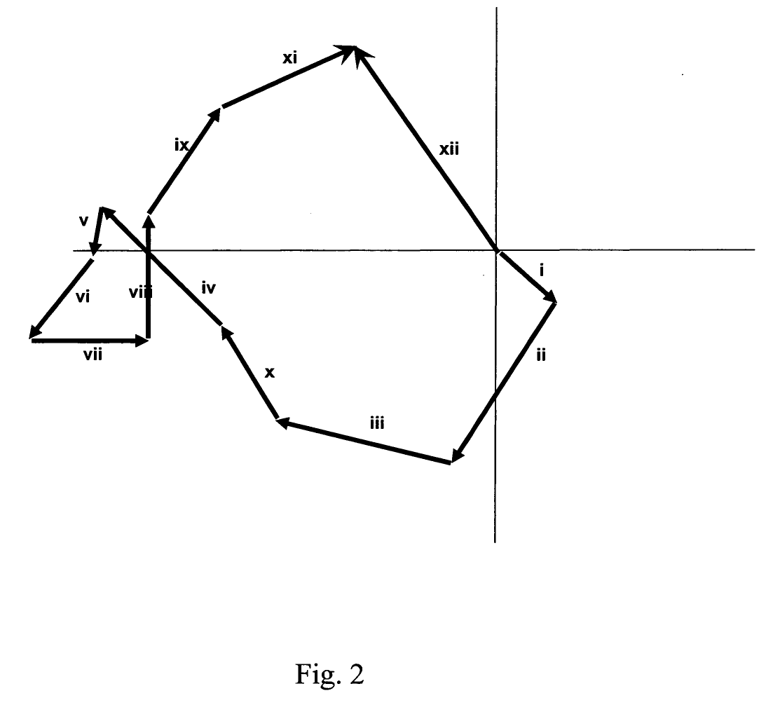

FIG. 2 is an example of a vector polar plot which shows the contributors to first harmonic of the carcass radial runout when no optimization has been applied. These include the various tooling vectors, product vectors, an intercept vector and the variable magnitude vectors. The tooling vectors are the 1^{st} (ii) and 2^{nd} (iii) stage building drum vectors, the tread building drum vector (iv) and the transfer ring vector (v). The building drums hold the carcass and tread as the tire is being built, while the transfer ring holds the tread as it is being placed onto the tire carcass. The product vectors are the belt ply vectors (vi and vii), cap vector (viii) and tread vector (ix). The belt ply is the protective steel belt, the cap is a nylon cover that goes over the belt ply and the tread is interface between the tire and the ground. The green tire radial runout is the vector sum of the components. The remaining, unidentified factors are consolidated in the Intercept vector (i) I1. This can be applied to all harmonics including harmonic 1. For consistency, we will subsequently refer to the uniformity attributes, such as Carcass FR, as applying to any harmonic.

The force-related attributes, which manifest themselves when the tire is rotating and are typically speed sensitive, are measured at high speed (typically 100-140 kph) and at low speed (typically 8-10 kph). Force-related, or dynamic, attributes will also consist of a set of values corresponding to a series of harmonics, that is, measurement values related to the frequency of appearance of the attribute during a rotation of the tire. Generally, the first harmonics (those occurring once per rotation) produce the largest magnitude forces, and are, accordingly, of the greatest interest for tire ride comfort. The method is also applicable to higher harmonics.

A uniformity attribute of interest is selected as or determined to be the target attribute. The target attribute may be of interest because of a particular requirement of an automobile manufacturer. Alternatively, the attribute may be determined to be the target because it has a high magnitude, which may be the result of a change in the tire manufacturing process or a change in materials.

The selected attributes are determined as vector quantities having a magnitude and a direction relative to the tire geometry. As pointed out above in regard to radial runout, a particular vector quantity represents the sum of the contributions to that attribute by different products or processes, which will be referred to as the input attributes. Mass variation for the tire will have contributions from the mass variation for each of the products and will represent the sum of those individual contributions. In addition, a particular product or process may contribute to more than one attribute. The tread, for example, may contribute to mass variation and may also contribute to the radial force variation.

Analyzing all possible attribute variations would be unwieldy. Accordingly, a method such as that disclosed in Chang, is used to relate the target attribute to other measured uniformity attributes. By relating the target attribute to the input attributes, the target attribute is defined in terms of a limited number of attributes that have the strongest influence on the target attribute, and may be easier to measure and/or easier to control through process change.

A relation of the target attribute to input attributes may be expressed as:

HV1=A*LV1+B*X+C+U (1)

where, HV1 is the high speed target attribute, LV1 is the low speed input attribute, X is a second input attribute, A and B are coefficients, C is a constant, and U represents all other inputs. The input attributes can be broken down into different tire process components, for example, X can be further broken down to include one part from the curing press and one part from the summit. Of course, additional input attributes may be included, but, for simplicity of the explanation, three inputs (LV, X, U) are used.

The attributes are vectors, and, thus, Equation 1 can be rewritten to express the vector quantities as the x and y components:

HV1ₓ=A_{1,1}*LV1ₓ+A_{1,2}*LV1_{y}+B_{1,1}*Xₓ+B_{1,2}*X_{y}+C1+U1 (2)

HV1_{y}=A_{2,1}*LV1ₓ+A_{2,2}*LV1_{y}+B_{2,1}*Xₓ+B_{2,2}*X_{y}+C2+U2 (3)

The equations given above can be applied to the second harmonic and up and will be expressed as HV2 to HVn. Of course, the coefficients will be different for the different harmonics.

Next, by using Principle Components Analysis (PCA), or other analysis techniques, the relative importance of each of the input attributes to the target attribute is determined. PCA is a technique for simplifying a dataset, by reducing multidimensional datasets to lower dimensions for analysis. A numerical value representing the importance of each input attribute is obtained from the PCA. Also, the input attributes are tested in groups to determine the amount of contribution to the target attribute. The result is groupings of input variables with an associated percentage value indicating what percentage of the target attribute is explained by each group.

From the determinations of the importance and the contribution, the overall contribution of a particular input attribute to the target attribute could be judged to be small and this attribute could be eliminated from further consideration without introducing significant error. Accordingly, the most significant input attributes are then selected for use in subsequent steps of the method of the invention, which simplifies the handling of the attributes.

The Partial Least Squares regression will determine the coefficients A_{1,1}, A_{1,2}, A_{2,1}, A_{2,2}, B_{1,1}, B_{1,2}, B_{2,1}, B_{2,2}, C₁, and C₂ for Equations 2 and 3. The magnitude of the coefficients suggest how much the associated attribute changes with speed. The coefficients for attribute magnitude values that are at or close to unity suggest, for example, that the associated attribute does not change appreciably with speed. The coefficients for attribute direction or angle values that are at or near zero suggest little or no change to vector direction.

Assuming for the purposes of this description that the unknown factor U can be ignored, Equations 2 and 3 may be rewritten as:

HV1ₓ=A_{1,1}*LV1ₓ+A_{1,2}*LV1_{y}+B_{1,1}*Xₓ+B_{1,2}*X_{y}+C1 (4)

HV1_{y}=A_{2,1}*LV1ₓ+A_{2,2}*LV1_{y}+B_{2,1}*Xₓ+B_{2,2}*X_{y}+C2 (5)

### In fact, as demonstrated by Principle Components Analysis of a series of tire test results, the contribution of U to HV is less than 5%.

The goal of reducing the magnitude of the high speed radial force variation can be addressed through control of the input attributes. One available avenue is in the direction of the input attribute vectors. Because the input attributes are vector quantities, both the magnitude and direction of the input attributes contributes to the target attribute. It is possible, therefore, to arrange vector directions so that the resultant target attribute is minimized.

The method starts with a carcass run-out measurement while the carcass is loaded on a drum, and inflated to between 15% and 85% of its maximum inflation value. The measurement can be made, for example, by means of a camera, or a laser imaging system. This Carcass FR will be separated into true runout (or confection effects such as the product vectors above), drum effects, and effects from carcass loading on the drum. The effects of carcass loading on the drum generally create Radial Force Variation (VR) opposite from the loading component of Carcass FR (the maximum force coincides with the minimum run-out). This is due to the effect of loading a carcass, which does not sit concentrically on the drum. This causes VR once the carcass is made to conform with the tread A specific coefficient of proportionality relates the portion of Carcass FR from loading to the VR, and is called K_{LOADING} or loading spring rate. The confection carcass run-out generally creates VR in phase with it (the maximum force coincides with the maximum confection carcass run-out) with a specific coefficient of proportionality, which relates the Carcass FR to the VR, and is called the K_{CARCASS} or carcass spring rate. The carcass spring rate and loading spring rate are calculated by regression analysis from a series of cured tire VR measurements.

For each Carcass FR measurement, the confection carcass run-out will be estimated by subtracting the average loading run-out and the average drum run-out from the Carcass FR. The average loading run-out and the drum run-out are evaluated by an initial regression analysis and then vectorially subtracted for each subsequent tire measurement. To build a model of VR from the Carcass FR, first the fixed loading VR signature is applied. The loading VR signature is the VR resulting from the average loading run-out, and it is calculated as the product of this average loading run-out by the loading spring rate. Then the VR confection is modeled. The confection VR is equal to the confection Carcass FR multiplied by the carcass spring rate. Finally, the Carcass VR is modeled as the sum of loading VR and the Confection VR.

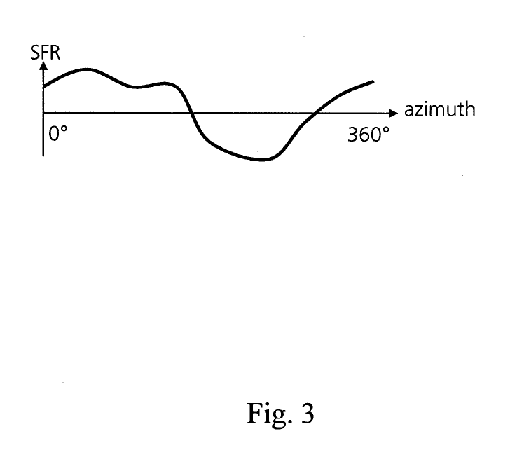

The tread thickness is measured around the circumference of the tread, at a minimum of 5 different angles evenly spaced, and preferably from 32 to 1024 different angles. At each angle, the thickness measurement will be made across the entire width of the tread, or across part of the width. The value at a given angle is the mean tread thickness across the measured width. The measurement can be made, for example, by means of a camera, or a laser imaging system. The measurement of tread thickness can be made before it is laid on the finishing drum, while on a belt, conveyor, or table, for example. Moreover, the measured tread might consist of the entire tread package or some part thereof. For instance, the tread belt or other part known to contribute to tread mass imbalance might be considered. FIG. 3 shows a mass variation curve for SFR, with each point on the curve representing a mean tread thickness at a given azimuth. The run-out of the drum, on which the tread is built, is also measured. The measured tread thickness equals the vector sum of the drum run-out and the true tread thickness. Of course, only the true tread thickness has an affect on the mass imbalance of the tire, as opposed to the contribution from the drum. To build a model of the tread mass imbalance from the tread thickness, it is assumed that the tread thickness variation is correlated to its mass variation. Thus, tread imbalance is equal to tread thickness multiplied by a mass conversion parameter. This mass conversion parameter is determined from a cured tire imbalance measurement and a regression model, with the intercept representing the non-tread mass imbalance. The values for the true tread thickness or the tread mass variation can be substituted for X, or the second input attribute, of Equation 1. Since the attributes are vectors, the equation can be rewritten to express the vector quantities as x and y coordinates, and the parameters can be determined using various mathematical methods.

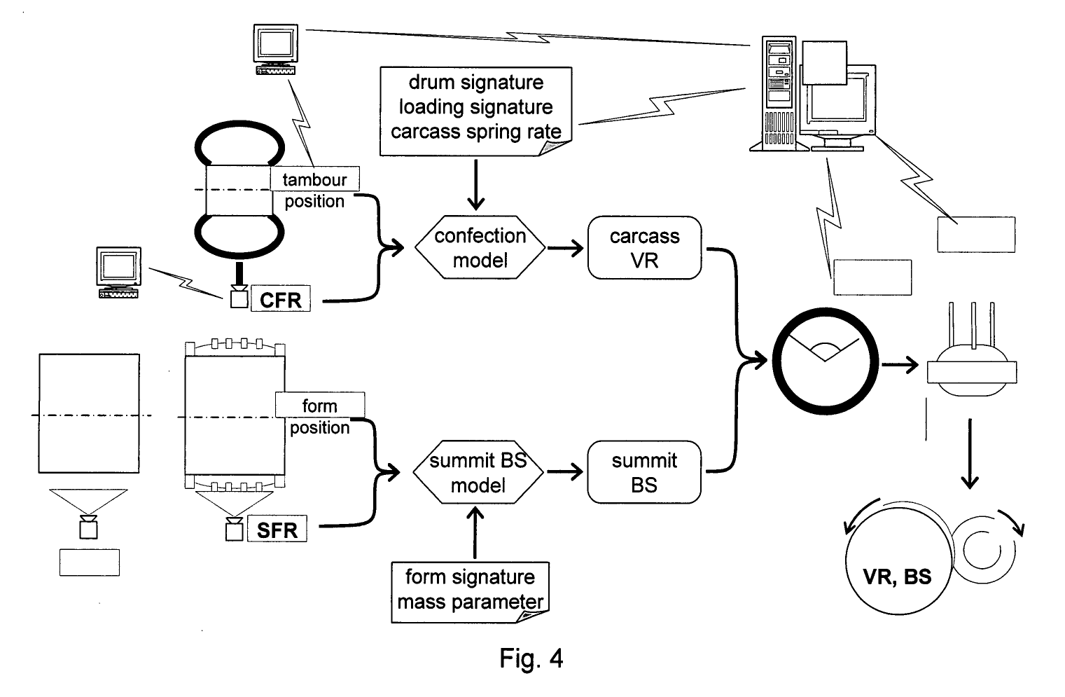

The above attribute models are applied to multiple optimization routines in order to improve the uniformity of the tire. The first routine includes creating a model of the Carcass VR by measuring the CFR. The drum position data is stored in a remote Server and the Server uses the drum and loading signature and the carcass spring rate along with the CFR measurements to create a confection model. In parallel, the drum run-out and tread thickness are measured. The drum run-out data is subsequently stored in a remote Server. The drum run-out data is then subtracted from the tread thickness measurement to generate a true tread thickness variation. The tread is applied on the carcass with an angular orientation such that the phase of the true tread thickness and Carcass VR are determined to achieve minimum HV magnitude as per Equation 1. The tire is then cured. The cured tire is measured for VR and the data is stored in a server. In the second embodiment, the cured tire is also measured for imbalance and this data is also stored in the Server. This data can then be applied as an input to the Tread mass imbalance model, generating tread mass imbalance from the tread thickness measurement. Carcass VR and tread mass imbalance can then be aligned to minimize HV. The final embodiment takes into account the angle of the tire in the curing press, which is optimized by an algorithm whose inputs are false round measurements during the tire building process. The optimization will consider a model of the effect of curing on the tire non-uniformity and then process the optimal angle for the green tire in the press by using a model. A depiction of this optimization routine is shown in FIG. 4.

1. A method for controlling the uniformity of tires in tire manufacture, comprising the steps of:
measuring a radial runout of an uncured tire carcass, wherein the measured radial runout is separated into separate components comprising confection effects, tire building drum effects, and effects from loading the carcass onto the tire building drum and conforming the carcass with a tire tread;
modeling a radial force variation contribution of the carcass from the above radial runout measurement;
measuring a thickness of the tire tread;
modeling mass imbalance of the tread from the thickness measurement;
forming a green tire by loading the said tread onto the said carcass at an angle whereby the radial force variation vector contribution of the carcass and the tread mass imbalance vector determined from the tread mass imbalance model minimizes any harmonic, or combination of harmonics, of green tire uniformity.

2. The method according to claim 1, wherein a first harmonic of the green tire uniformity is optimized.

3. The method according to claim 1, wherein the tread is loaded onto the carcass at an angle which minimizes a high speed uniformity of the cured tire.

4. The method according to claim 3, wherein the green tire is placed in a curing press at an angle which minimizes the high speed uniformity of the cured tire.

5. The method according to claim 4, wherein the radial runout measurement is made while the tire carcass is loaded onto the tire building drum.

6. The method according to claim 5, wherein the tread thickness is measured while the tread is on a tire building drum.

7. The method according to claim 3, wherein the tread thickness is measured before the tread is loaded on a tire building drum.

8. The method according to claim 6, wherein the tire carcass is partially inflated.

9. The method according to claim 6, wherein radial runout from confection effects is calculated by vectorial subtraction of an average loading radial runout and an average tire building drum radial runout, from the measured radial runout of the uncured tire carcass.

10. The method according to claim 9, wherein the step of modeling radial force variation of the carcass further comprises:
calculating a proportionality coefficient relating the radial runout of the carcass due to loading effects to radial force variation due to loading effects;
multiplying the loading proportionality constant by the average loading radial runout to calculate a loading radial force variation;
calculating a proportionality coefficient relating the radial runout of the uncured carcass due to confection effects to radial force variation due to confection effects;
multiplying the confection proportionality constant by the confection radial runout to calculate a confection radial force variation; and
a vector summation of the confection radial force variation and the loading radial force variation.

11. The method according to claim 10, wherein the tread thickness is calculated as the average value of measured thickness values across a portion of the width of the tread.

12. The method according to claim 10, wherein the tread thickness is calculated as the average value of measured thickness values across the entire width of the tread.

13. The method according to claim 10, wherein the proportionality coefficients are calculated using a regression analysis.

14. The method according to claim 10, wherein the proportionality coefficients are calculated at the same time.

15. The method according to claim 11, wherein the tread thickness measurement comprises measuring the tread band.

16. The method according to claim 11, wherein runout of a drum to build the tread is measured.

17. The method according to claim 3, wherein the radial force variation vector contribution of the carcass and the tread mass imbalance vector determined from the tread mass imbalance model are placed out-of-phase.

18. The method according to claim 3, wherein the radial force variation vector contribution of the carcass, the tread mass imbalance vector determined from the tread mass imbalance model, and at least one other uniformity attribute are combined to minimize the high speed uniformity of the tire.

19. The method according to claim 11, wherein the model of tread mass imbalance comprises:
calculating a proportionality coefficient relating the tread thickness to the tread mass imbalance;
multiplying the tread proportionality constant by the tread thickness to calculate the tread mass imbalance.

20. A tire built by the process comprising:
measuring a radial runout of an uncured tire carcass, wherein the measured radial runout is separated into separate components comprising confection effects, tire building drum effects, and effects from loading the carcass onto the tire building drum and conforming the carcass with a tire tread;
modeling a radial force variation contribution of the carcass from the above radial runout measurement;
measuring a thickness of the tire tread;
modeling mass imbalance of the tread from the thickness measurement;
forming a green tire by loading the said tread onto the said carcass at an angle whereby the radial force variation vector contribution of the carcass and the tread mass imbalance vector determined from the tread mass imbalance model minimizes any harmonic, or combination of harmonics, of green tire uniformity.
